(19) United States
(12) Patent Application Publication
(10) Pub. No.: US 2011/0156911 A1
(43) Pub. Date: Jun. 30, 2011

(54) OCCUPANCY-BASED CONTROL SYSTEM

(75) Inventor: Vincent John Caglianone, Tigard, OR (US)

(73) Assignee: LEVITON MANUFACTURING CO., INC., Melville, NY (US)

(21) Appl. No.: 12/649,697

(22) Filed: Dec. 30, 2009

(51) Int. Cl. G08B 23/00

(52) U.S. Cl. 340/573.1

(57) ABSTRACT

A system including an assembly; a sensor substantially encapsulated in the assembly and configured to sense an environment associated with the assembly to generate an occupancy signal; a wireless transmitter substantially encapsulated in the assembly; and a controller configured to transmit a remote control command with the wireless transmitter in response to the occupancy signal.

### BACKGROUND

Occupancy sensing technologies are used to monitor the presence of human occupants in indoor and outdoor spaces. Occupancy sensing systems can be used to conserve energy by automatically turning off lighting and other electrical loads when the space is unoccupied. For example, such lighting and other electrical loads can be connected to a lighting control system including an occupancy sensor. Thus, the occupancy sensor can be used in controlling power to such loads.

However, some electrical loads do not include a power control interface compatible with lighting control system or other automation systems. A device that can communicate with such systems can be placed inline with a power supply with such incompatible electrical loads. Unfortunately, some electrical loads include particular shut-down sequences that could be bypassed by a loss of power. Other electrical loads can lose programmed settings if power is disconnected.

### BRIEF DESCRIPTION OF THE DRAWINGS

FIG. 1 illustrates an embodiment of an occupancy-based control system according to some of the inventive principles of this patent disclosure.

FIG. 2 illustrates an embodiment of an occupancy sensor for an occupancy-based control system according to some of the inventive principles of this patent disclosure.

FIG. 3 illustrates an embodiment of an application of an occupancy-based control system according to some of the inventive principles of this patent disclosure.

FIG. 4 illustrates an embodiment of a transceiver according to some of the inventive principles of this patent disclosure.

FIG. 5 illustrates an embodiment of a transceiver in an occupancy-based control system according to some of the inventive principles of this patent disclosure.

FIG. 6 illustrates another embodiment of a transceiver in an automation system according to some of the inventive principles of this patent disclosure.

FIG. 7 illustrates another embodiment of an application of an occupancy-based control system according to some of the inventive principles of this patent disclosure.

### DETAILED DESCRIPTION

Some of the inventive principles of this patent disclosure relate to the use of an occupancy signal in a control system. In an embodiment, an occupancy signal can be used to control power of devices that are not otherwise connected to an automation system.

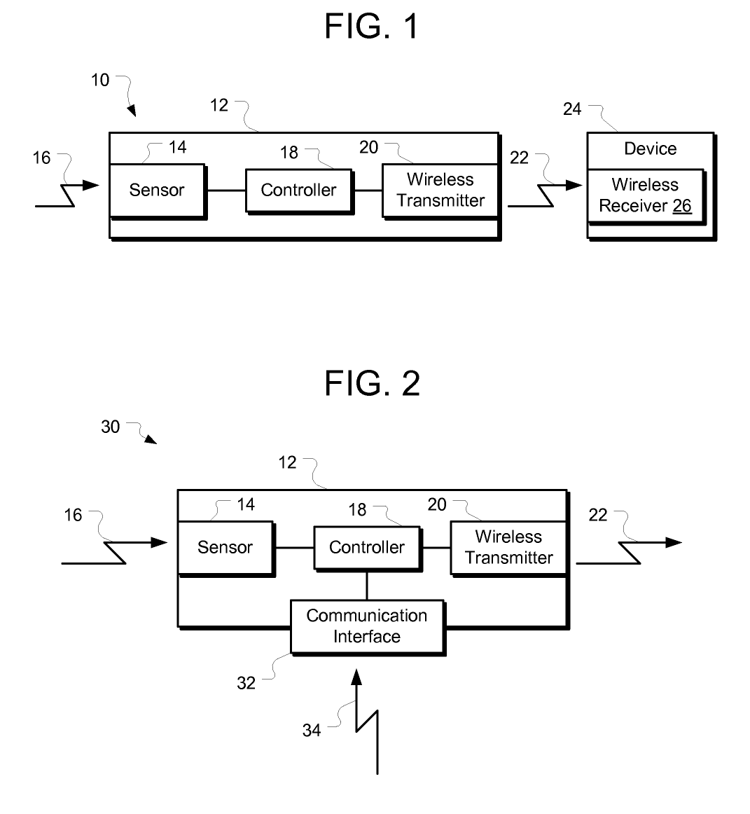

FIG. 1 illustrates an embodiment of an occupancy-based control system according to some of the inventive principles of this patent disclosure. In this embodiment, the occupancy sensor 10 includes an assembly 12, a sensor 14, a controller 18, and a wireless transmitter 20. The sensor 14, the controller 18, and the wireless transmitter 20 can be substantially encapsulated in the assembly 12. As used herein, substantially encapsulated can, but need not, include wholly encapsulated. For example, various signals 16 and 22 transmitted and received by the occupancy sensor 10 may pass through a wall of the assembly. Thus, the sensor 14, the controller 18, and the wireless transmitter 20 can be enclosed in the assembly 12. However, in another example, portions of the sensor 14, the controller 18, and the wireless transmitter 20 can be exposed through the assembly 12 to perform the associated functions, yet still be substantially encapsulated by the assembly 12.

The sensor 14 can be configured to sense an environment associated with the assembly 12 to generate an occupancy signal. The sensor 14 can be configured to sense a signal 16 that can be used in determining an occupancy state. For example, with an occupancy sensor based on passive-infrared (PIR) sensing technology, the occupancy sensor may include a semiconductor chip with one or more pyroelectric detectors that generate a voltage that changes in response to changes in the amount of infrared energy in the field of view. In another embodiment, the sensor 14 can include ultrasound detectors. A detected Doppler shift in the output from an ultrasound transducer can be used to detect occupancy. Although examples of sensors 14 have been given, other sensors and systems that can generate a signal indicative of an occupancy state can be used as the sensor 14. In an embodiment, each of these signals can vary based on a variety of different sensors 14 suitable in detecting occupancy.

Accordingly, the sensor 14 can be used to sense an occupancy state of a space. The space can be a room, an area, multiple rooms, a combination of such areas, or the like. The occupancy state can indicate whether the space is occupied or not. For example, the occupancy state can include an occupied state and an unoccupied state. The occupancy state can also include other information or different information. For example, the occupancy state can indicate how long the room has been occupied. Any information related to occupancy can be included in the occupancy state.

The controller 18 can be configured to make an occupancy determination by combining the information contained within the signals 16 received by multiple sensors 14, such as the PIR and ultrasound detectors. The controller 18 can be used in conjunction with the sensor 14 to determine the occupancy state. As described above, signals received by one or more sensors 14 can be incorporated by the controller 18 in generating an occupancy state.

The controller 18 can include any variety of circuitry. For example, in an embodiment, the controller 18 can be implemented as analog circuitry. In another embodiment, the controller 18 can include digital circuitry such as digital signal processors, programmable logic devices, or the like. In yet another embodiment, the controller 18 can include any combination of such circuitry. Any such circuitry and/or logic can be used to implement the controller 18 in analog and/or digital hardware, software, firmware, etc., or any combination thereof.

The wireless transmitter 20 can be a variety of devices. For example, the wireless transmitter 20 can be a radio frequency (RF) transmitter, an infrared (IR) transmitter, an ultrasonic transmitter, or the like. Any transmitter that can be used to transmit wirelessly can be used as the wireless transmitter 20.

In an embodiment the wireless transmitter 20 can be a transmitter appropriate to remote controllable devices. For example, a television could be the device 24. The television could have an infrared receiver as the wireless receiver 26. That is, the television can have an IR receiver configured to receive IR remote control commands from a hand-held remote control. The television may have no other control interface, such as an interface for an automation system.

The wireless transmitter 20 could be correspondingly configured to transmit infrared signals that, in conjunction with the controller 18, can be formatted to be understood by the television. For example, the wireless transmitter 20 can be controlled by the controller 18 to transmit a remote control command to the televisions with codes appropriate for the desired control of the television.

In an embodiment, the remote control command can be transmitted in response to the occupancy signal. For example, an unoccupied state can be sensed by the sensor 14. In response the controller can transmit an off remote control command associated with the television through the wireless transmitter 20. Thus, in an embodiment, the television would be turned off if a room is unoccupied. Similarly, in response to an occupied state indicating that a room is occupied, the controller 18 can transmit an on command associated with the television with the wireless transmitter 20. Thus, when the room is occupied, the television can be turned on.

As described above, a remote control command can be an on or off command that a hand-held remote control can transmit. However, the remote control command can include other commands. For example, the remote control command can include a channel change command, a number entry such as 0-9, a chapter skip command if the device 24 is a DVD player, a volume control command for an audio receiver, or the like. Any command that a remote control for a device 24, such as a hand-held remote control, would be capable of transmitting can be a remote control command that can be transmitted through the wireless transmitter 20.

Although the remote control command that is transmitted with the wireless transmitter 20 has been described as appropriate to the device 24, other remote control commands can be transmitted. In an embodiment, remote control commands for a variety of different devices 24 can be transmitted. These remote control commands can be associated with particular devices 24 installed with the occupancy sensor 10. In another example, the remote control commands can be for expected devices, all devices known to the occupancy sensor 10, or the like.

That is, the remote control commands that are transmitted can cover a variety of devices that may or may not include the devices 24 that are actually installed. In an embodiment, the occupancy sensor 10 can be installed in a room with unknown devices. The occupancy sensor 10 can be programmed with remote control commands for a variety of devices. When an occupancy signal is received, the controller 18 can transmit associated remote control commands to the unknown devices. As multiple remote control commands can be transmitted, the likelihood that a remote control command appropriate for the unknown devices will be transmitted is increased.

In an embodiment, the remote control commands can have different formats. Thus, one remote control command may not be understood, or may be rejected by some devices. The remote control commands can be transmitted in the different formats. As used herein, different formats can include different codes, different modulation techniques, or the like. Furthermore, the remote control commands transmitted by the wireless transmitter 20 can, but need not, be through different types of wireless transmitters. As described above, different devices can respond to different media. An occupancy sensor 10 could include multiple wireless transmitters 20, such as an IR transmitter, an RF transmitter, and an ultrasonic transmitter. Thus, not only can remote control commands be transmitted using different techniques in a single medium, but also in different media.

FIG. 2 illustrates an embodiment of an occupancy sensor for an occupancy-based control system according to some of the inventive principles of this patent disclosure. In this embodiment the occupancy sensor 30 includes a sensor 14, controller 18, and wireless transmitter 20 similar to the occupancy sensor 10 described above. However, the occupancy sensor 30 also includes a communication interface 32. The communication interface 32 can be substantially encapsulated in the assembly 12.

The communication interface 32 can be a variety of different interfaces. For example, the communication interface 32 can be a wired or wireless interface, a standardized and/or proprietary automation system interface, or the like. The communication interface 32 can include interfaces such as an Ethernet interface, a Z-Wave interface, an X10 interface, a ZigBee interface, or the like.

In an embodiment, the communication interface 32 can be configured to communicate with an automation system, such as a lighting control system. Signals 34 represent signals from such a control system. Although illustrated as wireless signals, as described above, the signals 34 can be wired signals. Accordingly, the communication interface 32 can allow the controller 18 to interoperate with a control system. In an embodiment, the control system can adjust whether the controller 18 will transmit the remote control commands in response to the occupancy state. For example, although a hotel operator may want the television to turn on and off based on occupancy of a lounge, the operator may want the system to be disabled during the night. Although the controller 18 can be configured perform such a function, the controller 18 can also respond to such instructions from the control system through the control interface 32.

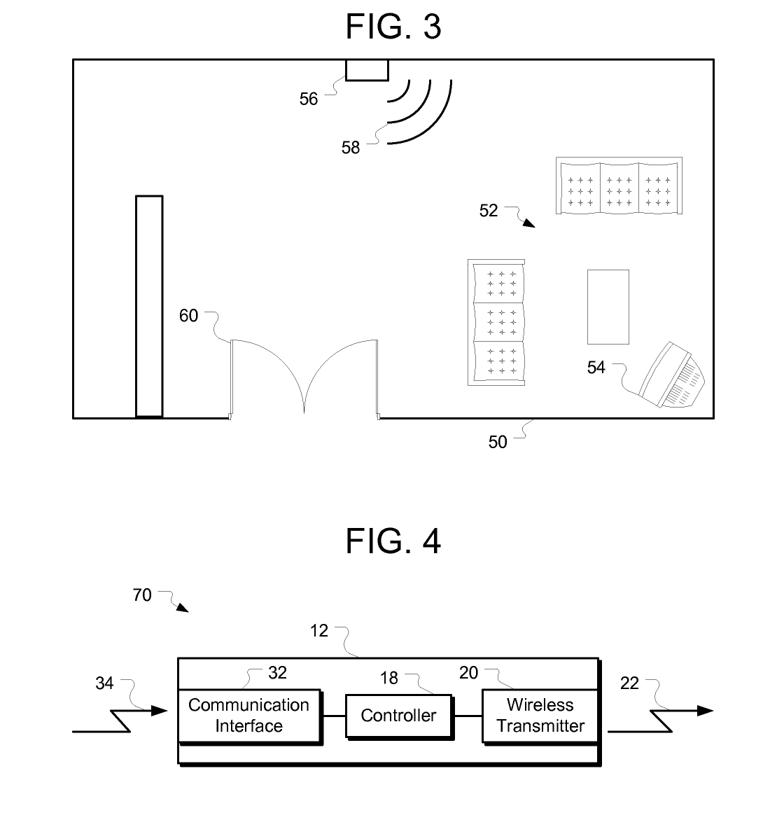

FIG. 3 illustrates an embodiment of an application of an occupancy-based control system according to some of the inventive principles of this patent disclosure. In this embodiment the occupancy-based control occupancy sensor 56 can be similar to the occupancy sensors 10 and 30 described above. The occupancy sensor 56 can be installed in a room 50, such as a lobby of a hotel. The room 50 includes a lounge area 52 including a television 54. The television 54 can have a wireless control interface such as an IR remote control interface as describe above. The room 50 could also have additional devices, such as audio/visual systems, additional televisions, displays, DVD players, internet kiosks, cable boxes, satellite television tuners, or the like.

The occupancy sensor 56 can be configured to transmit an IR signal 58 to the television 54 in response to an occupancy state of the room 50. For example, as described above, if an occupant is sensed in the room, the occupancy sensor 56 can transmit an on remote control command to the television 54. Furthermore, the occupancy sensor 56 can transmit on remote control commands to other devices in the room 50. Thus, the devices can remain off if there are no occupants and turn on when someone enters the room 50.

In an embodiment, the sensing region of the sensor 14 of the occupancy sensor 56 can, but need not, extend over the entire room 50. For example, the sensing region of the sensors 14 can cover only the lounge area 52. That is, the space from which an occupancy state is generated can be less than all of the room 50.

Furthermore, although the occupancy sensor 56 has been illustrated as mounted on a wall of the room 50, the occupancy sensor 56 could be located with the devices to be controlled. In an embodiment, the occupancy sensor 56 can be located in a kiosk along with the associated devices. For example, in a kiosk located in a shopping area, power and/or other controls for advertising displays, shopper interfaces, or the like can be controlled.

FIG. 4 illustrates an embodiment of a transceiver according to some of the inventive principles of this patent disclosure. In this embodiment, the transceiver 70 can be similar to the occupancy sensors 10 or 30 described above, but need not include a sensor 14. The transceiver 70 can include a communication interface 32, a controller 18, and a wireless transmitter 20 as described above. The controller 18 and wireless transmitter 20 can be similarly configured to transmit remote control commands 22 to various devices. The communication interface 32, the controller 18, and the wireless transmitter 20 can all be substantially encapsulated in an assembly 12.

The communication interface 32 can be configured to receive an occupancy signal through the received signals 34. In an embodiment the occupancy signal can indicate an occupancy state. Accordingly, the controller 18 can transmit remote control commands in response to the occupancy state even though the controller 18 is separate from an occupancy sensor. Moreover, the communication interface 32 can also allow the transceiver 70 to be used without occupancy states or signals. For example, as will be described in further detail below, the communication interface can allow the transceiver 70 to be controlled by an automation system.

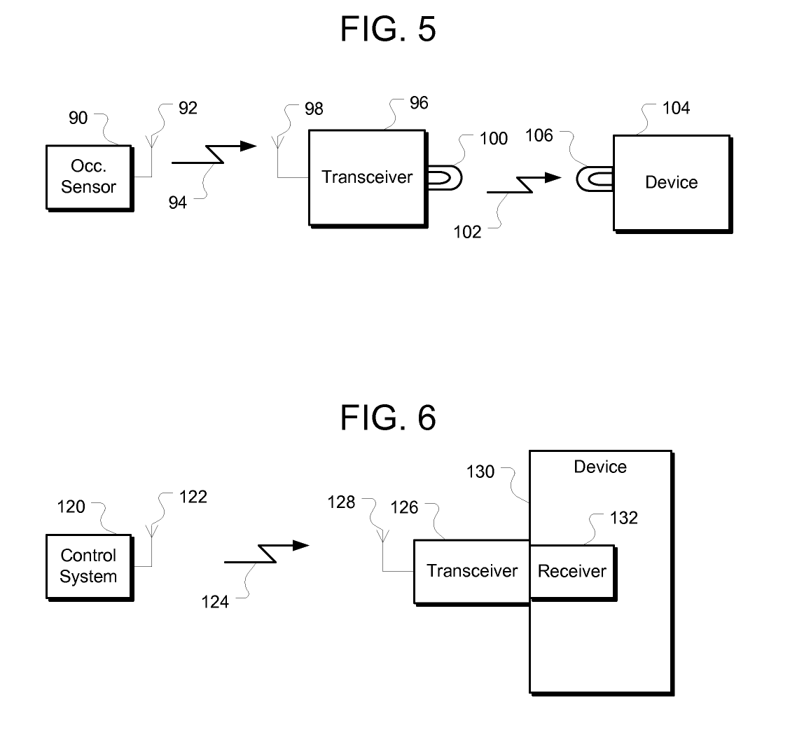

FIG. 5 illustrates an embodiment of a transceiver in an occupancy-based control system according to some of the inventive principles of this patent disclosure. In this embodiment, the system includes an occupancy sensor 90 with a wireless interface 92. The occupancy sensor 90 can transmit an occupancy signal 94 which can be received by a wireless receiver 98 of a communication interface of the transceiver 96. The transceiver 96 can be similar to the transceiver 70. In this embodiment the transceiver 96 has an IR transmitter which can transmit the remote control commands 102 to an IR receiver 106 of device 104.

In this embodiment, the occupancy sensing circuitry of the occupancy sensor 90 need not be collocated with the transceiver 96. A suitable location to sense the occupancy of a space can be an inconvenient location for transmitting an IR signal 102 from the transceiver 96 to the device 106. Accordingly, the transceiver 96 can be placed in a more suitable location for IR transmission, such as a line-of-sight location, which may be unsuitable for detecting occupancy of the room 50.

Although the communication between the occupancy sensor 90 and the transceiver 96 have been described as having wireless interfaces 92 and 98, the occupancy sensor 90 and transceiver 96 can communicate through any communication link. For example, the occupancy sensor 90 and the transceiver 96 can be coupled through an Ethernet network, an automation system network, or the like.

FIG. 6 illustrates another embodiment of a transceiver in an automation system according to some of the inventive principles of this patent disclosure. In this embodiment the transceiver 126 is mounted to the device 130. In particular, the transceiver 126 is mounted such that the receiver 132 of the device 132 is aligned to the wireless transmitter of the transceiver 126. For ease of illustration, the wireless transmitter of the transceiver 126 is not illustrated.

The transceiver 126 has a wireless interface 128 through which the transceiver can communicate with a control system 120, such as an automation system. In an embodiment, the control system 120 can transmit an occupancy signal 124 to the transceiver 126. The transceiver 126 can transmit the remote control command to the device 130 in response. In another embodiment, the control system 120 can transmit other signals 124 to the transceiver other than an occupancy signal to control transmission of remote control commands to the device 130.

Accordingly, the transceiver 126 can allow the control system 120 to extend control to the device 130. In particular, control can be extended to devices 130 that are not configured to be controlled by the system 120. That is, devices not capable of communicating with a control system can be controlled through the transceiver 126. Moreover, the control of such devices 130 can be more suitable to the devices 130. That is, a power-off procedure of a device 130 can be engaged that would otherwise be circumvented if the power supply to the device 130 was disconnected. Setting that may otherwise have been lost when power is disconnected can be maintained while still conserving power from shutting down the device 130.

In addition, devices 130 can be installed in locations where the receiver 132 would be obscured. For example the receiver 132 of the device 130 may be concealed behind some decorative trim, supports for a multi-unit display, or the like. The transceiver 126 can be installed behind such obstructions, yet have a wireless interface 128, such as an RF interface, that can penetrate the obstructions.

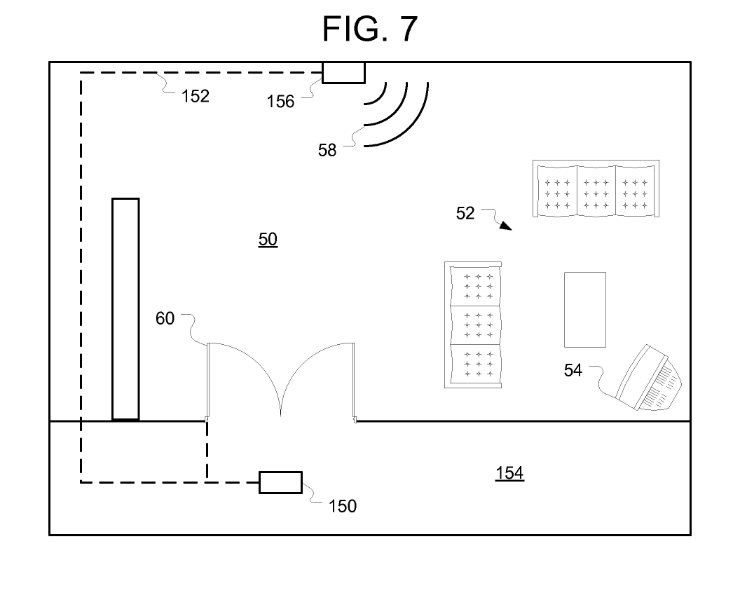

FIG. 7 illustrates another embodiment of an application of an occupancy-based control system according to some of the inventive principles of this patent disclosure. As described above, the occupancy sensing circuitry may be in the same room as the wireless transmitter and devices configured to receive the remote control commands. In this embodiment, the occupancy sensing circuitry can be in a different space than the devices configured to receive the remote control commands.

For example, room 50 includes the television 54 in the area 52 as described above. However, the occupancy sensor 150 is located in a hall 154 outside of the room 50. The occupancy sensor 150 is connected to the transceiver 156 through a communication link 152. The communication link 150 can be an automation network, a wireless or wired network, or the like. Accordingly, the occupancy state can be communicated from the occupancy sensor 150 to the transceiver 156. Moreover, other inputs can be used in the transmission of remote control commands to the television 54 or other devices. For example, a sensor on the door 60 can also be connected to the communication link 152. Regardless of whether the communication flow is through a central controller or directly with the transceiver 156 the transceiver can transmit the remote control commands in response to the other inputs.

The inventive principles of this patent disclosure have been described above with reference to some specific example embodiments, but these embodiments can be modified in arrangement and detail without departing from the inventive concepts. For example, some of the embodiments have been described in the context of particular devices that can respond to remote control commands, but the inventive principles apply to other types of devices with wireless interfaces as well. Any of the circuitry and logic described herein may be implemented in analog and/or digital hardware, software, firmware, etc., or any combination thereof. As another example, some of the embodiments have been described in the context of interior building spaces, but the inventive principles apply to exterior or hybrid spaces as well. Such changes and modifications are considered to fall within the scope of the following claims.

1. A system comprising:
an assembly;
a sensor substantially encapsulated in the assembly and configured to sense an environment associated with the assembly to generate an occupancy signal;
a wireless transmitter substantially encapsulated in the assembly; and
a controller configured to transmit a remote control command with the wireless transmitter in response to the occupancy signal.

2. The system of claim 1, wherein the wireless transmitter is an infrared transmitter.

3. The system of claim 1, wherein the remote control command is an off command.

4. The system of claim 3, wherein the controller is configured to transmit the off command in response to the occupancy signal indicating an unoccupied state.

5. The system of claim 1, wherein the remote control command is an on command.

6. The system of claim 5, wherein the controller is configured to transmit the on command in response to the occupancy signal indicating an occupied state.

7. The system of claim 1, wherein the controller is configured to transmit a plurality of remote control commands with the wireless transmitter in response to the occupancy signal, wherein each of the remote control commands is associated with a different device.

8. The system of claim 7, wherein each of the remote control commands encodes a control command in a format different from the other remote control commands.

9. The system of claim 1, further comprising a communication interface substantially encapsulated in the assembly and substantially separate from the wireless transmitter, wherein the controller is configured to communicate with an automation system through the communication interface.

10. A transceiver comprising:
an assembly;
a communication interface substantially encapsulated in the assembly and configured to receive an occupancy signal;
a wireless transmitter substantially encapsulated in the assembly; and
a controller configured to transmit a remote control command with the wireless transmitter in response to the occupancy signal.

11. The transceiver of claim 10, wherein the wireless transmitter is an infrared transmitter.

12. The transceiver of claim 10, wherein the controller is configured to transmit a plurality of remote control commands with the wireless transmitter in response to the occupancy signal, wherein a format of each of the remote control commands is associated with a different device.

13. The transceiver of claim 10, wherein the assembly is configured to be mounted to a device with a wireless receiver such that the wireless transmitter is aligned to the wireless receiver.

14. A method, comprising:
sensing an occupancy state of a space; and
wirelessly transmitting a remote control command in response to the occupancy state.

15. The method of claim 14, wherein wirelessly transmitting the remote control command further comprises transmitting the remote control command with an infrared transmitter.

16. The method of claim 14, further comprising:
sensing an unoccupied state of the space; and
wirelessly transmitting an off command as the remote control command.

17. The method of claim 14, wherein wirelessly transmitting the remote control command comprises wirelessly transmitting a plurality of remote control commands, each remote control command having a different format and associated with a different device.

18. The method of claim 14, further comprising:
sensing an occupied state of the space; and
wirelessly transmitting an on command as the remote control command.

19. The method of claim 14, further comprising:
receiving an occupancy signal encoding the occupied state through a network for an automation system;
wherein wirelessly transmitting the remote control command comprises wirelessly transmitting the remote control command in response to the occupancy signal.

20. A system comprising:
a device with a wireless control interface;
an occupancy sensor;
a wireless transmitter; and
a controller configured to transmit a remote control command with the wireless transmitter to the device in response to the occupancy sensor.

21. The system of claim 20, wherein the device is a television.

22. The system of claim 20, wherein the device is an audio/visual system.

23. The system of claim 20, wherein the occupancy sensor, the device, and the wireless transmitter are in substantially the same room.

24. The system of claim 20, wherein the occupancy sensor is in a room substantially separate from the device and the wireless transmitter.

25. The system of claim 20, further comprising an automation system network, wherein the occupancy sensor and the controller are coupled together through the automation system network.
